(19) United States
(12) Patent Application Publication
(10) Pub. No.: US 2016/0071043 A1
(43) Pub. Date: Mar. 10, 2016

(54) ENTERPRISE SYSTEM WITH INTERACTIVE VISUALIZATION

(71) Applicant: INTERNATIONAL BUSINESS MACHINES CORPORATION, Armonk, NY (US)

(72) Inventors: Igor A. NAUMOV, Plano, TX (US); David R. SLOAN, Farmers Branch, TX (US)

(21) Appl. No.: 14/477,046

(22) Filed: Sep. 4, 2014

(51) Int. Cl. G06Q 10/06; G06F 3/0484

(52) U.S. Cl. CPC G06Q 10/06315; G06Q 10/06316; G06Q 10/067; G06F 3/04842

(57) ABSTRACT

Approaches for interacting with business process content on a computing device are provided. An approach includes aggregating business process data from base lists into business process chains or scenarios comprising at least one link between two or more business processes. The approach further includes displaying, at a computing device with a screen display, at least a portion of a business solution on the screen display. The portion of the business solution includes the business process chains or scenarios. The approach further includes detecting a first input at a location of a first item of the business process chains or scenarios on the displayed portion of the business solution. The approach further includes in response to the detecting the first input, selecting the first item and manipulating the first item on the displayed portion of the business solution relative to other items of the business process chains or scenarios.

### FIELD OF THE INVENTION

The present invention generally relates to enterprise systems, and more particularly, to a method and system for interacting with business process model data in real time and visually displaying the integration points and dependencies between business processes.

### BACKGROUND

An enterprise system (ES), such as an enterprise resource planning (ERP) system, is characteristically a large-scale application software package that supports business processes, information flows, reporting, and data analytics in an enterprise, e.g., a corporation. A typical ERP system covers multiple functional areas of an enterprise including financial accounting, management accounting, human resources, manufacturing, order processing, supply chain management, project management, customer relationship management, and data services. The business processes of these various functional areas that are supported by the ERP system are a collection of related, structured activities or tasks that produce a specific service or product that serves a particular goal of the functional area and/or the enterprise. The business processes include the flow and use of information and resources.

The ERP system may be configured to support the integrated nature of business processes across functional areas of the enterprise using common business data maintained by a database management system. For example, the business processes can often be represented in a visual way as executed through the ERP system with a flowchart or process model presented as a sequence of activities with interspersed decision points or with a process matrix as a sequence of activities with relevance rules based on data in the business processes. Additionally, the ERP system tracks business resources, e.g., cash, raw materials, production capacity, and the status of business commitments, e.g., orders, purchase orders, and payroll. The application components that make up the ERP system typically share data across the various functional areas (e.g., manufacturing, purchasing, sales, accounting, etc.) that each provide the data for their respective areas. The ERP system thus facilitates information flow between all functional areas, and manages connections to outside stakeholders, e.g., a particular customer or customers. Consequently, business processes are highly integrated in the ERP system and understanding the relationship between multiple business processes can be a challenge for users of the ERP system. Conventional systems and methods rely on human knowledge, manually maintained documentation, and testing to understand the business process integration and dependencies within the ERP system.

### SUMMARY

In a first aspect of the invention, a method is provided for that includes aggregating business process data from base lists into business process chains or scenarios comprising at least one link between two or more business processes. The method further includes displaying, at a computing device with a screen display, at least a portion of a business solution on the screen display. The portion of the business solution includes the business process chains or scenarios. The method further includes detecting a first input at a location of a first item of the business process chains or scenarios on the displayed portion of the business solution. The method further includes in response to the detecting the first input, selecting the first item and manipulating the first item on the displayed portion of the business solution relative to other items of the business process chains or scenarios. The method further includes detecting a second input at a location of a second item of the business process chains or scenarios on the displayed portion of the business solution. The method further includes in response to the detecting the second input, expanding the second item to display additional items of the business process chains or scenarios on the screen display including the at least one link between the two or more business processes.

In another aspect of the invention, a computer program product for assessing and displaying business process data is provided for that includes a computer readable storage medium having program instructions embodied therewith. The program instructions are readable by a computing device to cause the computing device to retrieve business processes and associated objects from a database that are relevant to a received request for the business process data. A first object of the associated objects for a first business process of the business processes is configured to reference a second object of the associated objects for a second business process of the business processes, which implements an interface or link between the first business process and the second business process. The program instructions are also readable by the computing device to further cause the computing device to generate one or more base lists comprising the business processes and the associated objects. The program instructions are also readable by the computing device to further cause the computing device to aggregate the business processes and the associated objects from the one or more base lists into business process chains or scenarios comprising the interface or link between the first business process and the second business process. The program instructions are also readable by the computing device to further cause the computing device to display a graphical user interface including at least a portion of a business solution on a screen display. The portion of the business solution includes the business process chains or scenarios.

In a further aspect of the invention, system is provided for that includes a CPU, a computer readable memory and a computer readable storage medium. The system further includes program instructions to model business processes. The system further includes program instructions to analyze the modeled business processes and determine links between the business processes at their integration points. The system further includes program instructions to store the modeled business processes and the determined links between the business processes in a database. The system further includes program instructions to receive a query pertaining to business processes. The system further includes program instructions to retrieve one or more modeled business processes and associated links between the one or more business processes from the database based on the query. The system further includes program instructions to generate and display base lists comprising the retrieved one or more modeled business processes. The system further includes program instructions to detect a first input at a location of a first item of the retrieved one or more modeled business processes. The system further includes program instructions that in response to the detecting the first input, filter and display the retrieved one or more modeled business processes based on the first item. The displaying the retrieved one or more modeled business processes based on the first item includes displaying a total number of business processes related to each of the one or more modeled business processes based on the determined links between the business processes. The program instructions are stored on the computer readable storage medium for execution by the CPU via the computer readable memory.

### BRIEF DESCRIPTION OF THE SEVERAL VIEWS OF THE DRAWINGS

The present invention is described in the detailed description which follows, in reference to the noted plurality of drawings by way of non-limiting examples of exemplary embodiments of the present invention.

FIG. 1 shows an illustrative environment for implementing the steps in accordance with aspects of the invention.

FIG. 2 shows a high level architecture for implementing processes in accordance with aspects of the invention.

FIG. 3 shows an exemplary flow in accordance with aspects of the invention.

FIGS. 4-9 show visual representations of examples of operation in accordance with aspects of the invention.

FIGS. 10 and 11 show exemplary flows in accordance with aspects of the invention.

### DETAILED DESCRIPTION

The present invention generally relates to enterprise systems, and more particularly, to a method and system for interacting with business process model data in real time and visually displaying the integration points and dependencies between business processes. More specifically, implementations of the invention provide systems and methods to leverage a modeling tool database such as IBM® Business Process Manager to model business processes and link the business processes at their process integration points (IBM is a trademark of International Business Machines Corporation registered and unregistered in many jurisdictions worldwide). In embodiments, a query of the modeling tool database may be performed, and the resulting data may be presented to a user in an interactive base list and a graphical user interface (GUI) format.

To this end, in embodiments, a base list tool, in response to a query, may be configured to generate base lists comprising business process details including process integration points, and a interface tool may be configured to visualize or illustrate the business processes with the process integration points from the base lists. For example, the interface tool may interpret the base lists to perform appropriate aggregations to present visualizations appropriately grouped into business process chains or scenarios. In embodiments, the illustrations of the business processes may be interacted with by a user via the interface tool to identify business process dependencies, evaluate impacts of changes to individual business processes, and evaluate completeness of solution design as represented by the business process models. Advantageously, in embodiments, the systems and methods of the present invention allow for a user to not only visualize the interactions of the business processes but interact with them to determine change impacts and additional information.

In embodiments, the base list tool and interface tool allow business process owners and other enterprise stakeholders to quickly see the relationships between and amongst business processes that may or may not cross functional areas of the enterprise. In accordance with aspects of the present invention, the interface tool is configured to present the display of an enterprise solution based off of process models maintained in business process modeling software, which essentially limits the need for maintaining the process relationships. Accordingly, the interface tool provides a holistic view of the end-to-end enterprise solution that is not visible whilst modeling individual business processes or when connecting business processes into value added chains known as business scenarios.

In more specific embodiments, the interface tool is configured to provide real-time visibility to implications of related business processes when the business is considering a change to any one business process. By illustrating the integration and dependencies between business processes, the interface tool is capable of providing business stakeholders insight into the potential impact of business process changes under consideration prior to implementing the changes in a manner not previously available via conventional systems and methodologies. Accordingly, the interface tool allows for business analysts and process owners to understand and audit business activities based on job roles for the purpose of job definition, separation of duties and compliance audits, and for planning and developing training.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon. The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

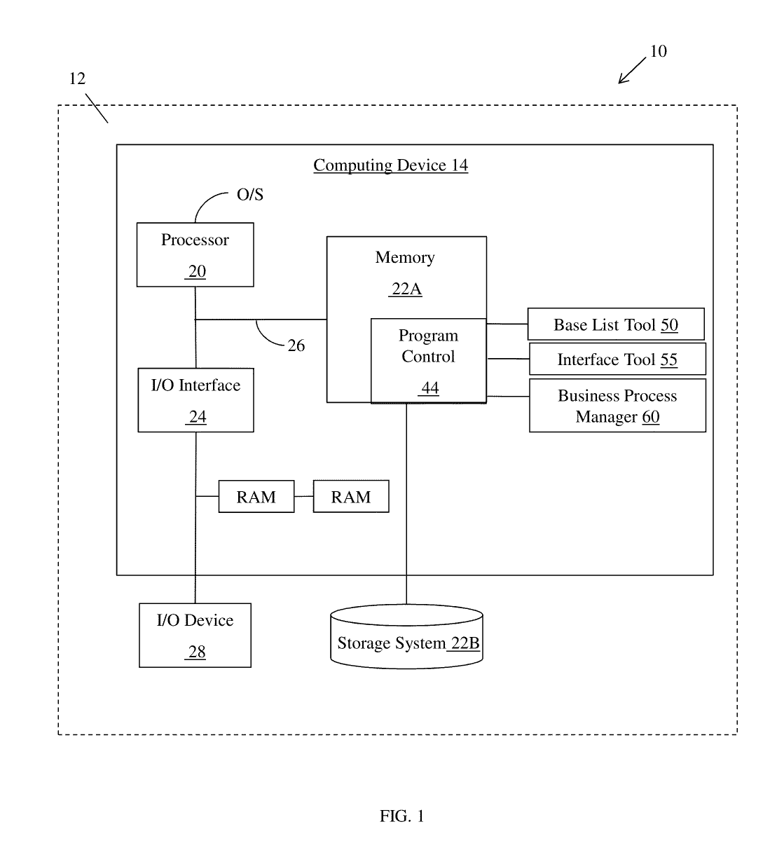

FIG. 1 shows an illustrative environment 10 for managing the processes in accordance with the invention. To this extent, environment 10 includes a server 12 or other computing system that can perform the processes described herein. In particular, server 12 includes a computing device 14. The computing device 14 can be resident on a network infrastructure or computing device of a third party service provider (any of which is generally represented in FIG. 1).

The computing device 14 also includes a processor 20 (e.g., CPU), memory 22A, an I/O interface 24, and a bus 26. The memory 22A can include local memory employed during actual execution of program code, bulk storage, and cache memories which provide temporary storage of at least some program code in order to reduce the number of times code must be retrieved from bulk storage during execution. In addition, the computing device includes random access memory (RAM), a read-only memory (ROM), and an operating system (O/S).

The computing device 14 is in communication with external I/O device/resource 28 and storage system 22B. For example, I/O device 28 can comprise any device that enables an individual to interact with computing device 14 or any device that enables computing device 14 to communicate with one or more other computing devices using any type of communications link. The external I/O device/resource 28 may be for example, a screen display, a handheld device, PDA, handset, keyboard etc.

In general, processor 20 executes computer program code (e.g., program control 44), which can be stored in memory 22A and/or storage system 22B. Moreover, in accordance with aspects of the invention, program control 44 controls a base list tool 50, an interface tool 55, and a business process manager 60, e.g., tools of an enterprise system or business process management application such as IBM Business Process Manager, which perform the processes described herein. The base list tool 50, interface tool 55, and business process manager 60 can be implemented as one or more program code in program control 44 stored in memory 22A as separate or combined modules. Additionally, the base list tool 50, interface tool 55, and business process manager 60 may be implemented as separate dedicated processors or a single or several processors to provide the functions of the tools and manager. While executing the computer program code, the processor 20 can read and/or write data to/from memory 22A, storage system 22B, and/or I/O interface 24. The program code executes the processes of the invention. The bus 26 provides a communications link between each of the components in computing device 14.

The computing device 14 can comprise any general purpose computing article of manufacture capable of executing computer program code installed thereon (e.g., a personal computer, server, etc.). However, it is understood that computing device 14 is only representative of various possible equivalent-computing devices that may perform the processes described herein. To this extent, in embodiments, the functionality provided by computing device 14 can be implemented by a computing article of manufacture that includes any combination of general and/or specific purpose hardware and/or computer program code. In each embodiment, the program code and hardware can be created using standard programming and engineering techniques, respectively.

Similarly, server 12 is only illustrative of various types of computer infrastructures for implementing the invention. For example, in embodiments, server 12 comprises two or more computing devices (e.g., a server cluster) that communicate over any type of communications link, such as a network, a shared memory, or the like, to perform the process described herein. Further, while performing the processes described herein, one or more computing devices on server 12 can communicate with one or more other computing devices external to server 12 using any type of communications link. The communications link can comprise any combination of wired and/or wireless links; any combination of one or more types of networks (e.g., the Internet, a wide area network, a local area network, a virtual private network, etc.); and/or utilize any combination of transmission techniques and protocols.

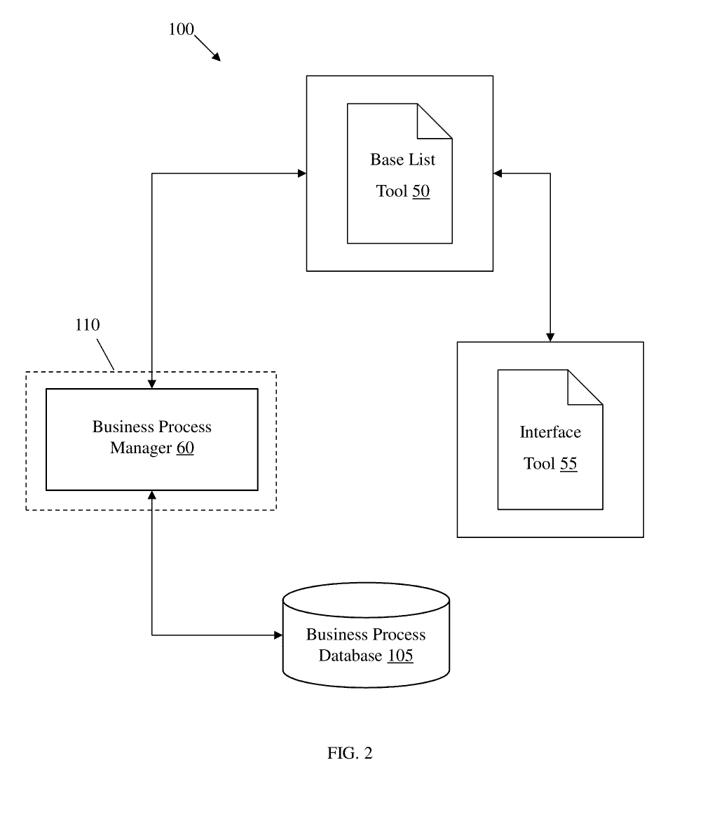

FIG. 2 is a high level architecture for implementing processes in accordance with aspects of the present invention. More specifically, FIG. 2 depicts an enterprise system 100 comprising business process manager 60 (as described with respect to FIG. 1) in communication with base list tool 50 (as described with respect to FIG. 1), an interface tool 55 (as described with respect to FIG. 1), and a business process database 105 (e.g., a business process storage system 22B as discussed with respect to FIG. 1). The business process manager 60 may be, for example, a unified platform for analyzing and improving business operations through a combination of business process and basic case management, service-oriented architecture (SOA) and business process analytics. The business process manager 60 may be a known manager such as IBM® Business Process Manager configured to receive specific calls from a user with specific information formatted for the manager or a generic manager with representational state transfer (REST) services (e.g., services provided by a third party service provider) that are configured to receive generic calls from a user with information not necessarily formatted for the manager.

In embodiments, the business process manager 60 may be configured to analyze and model business processes. For example, the business process manager 60 may be configured to provide users with the ability to model business processes, implement and execute those models, and refine the models based on as-executed data. As a result, the business process manager 60 can provide transparency into business processes, as well as the centralization of corporate business process models and execution metrics. Modeling and simulation functionality from the business process manager 60 allows for pre-execution “what-if” modeling and simulation. Post-execution optimization may be available through the business process manager 60 based on the analysis of actual as-performed metrics. As should be understood by those of ordinary skill in the art, the business process manager 60 may use any number or combination of modeling techniques, such as Business Process Model and Notation, Unified Modeling Language, and Extended Business Modeling Language, in order to model the business processes without departing from the spirit and scope of the present invention.

The business process manager 60 may be further configured to link the business processes at their process integration points. For example, the business process manager 60 may be configured to determine one or more points in a business process where one or more other business processes are integrated with the business process. In other words, the business process manager 60 may be configured to discover each instance where a business process is affected by another business process, and determine that instance as an integration point between the two business processes. Once the points of integration are determined, the business process manager 60 may configure a property (e.g., data field) of an object for one of the integrated business processes to reference an object for the other of the integrated business processes, which implements an interface or link between the two business processes. The modeled business processes including their associated objects and links may then be stored in the business process database 105. In embodiments, the modeled business processes may be stored with reference to associated business scenarios and solutions, e.g., as a business flowchart

In embodiments, the base list tool 50 may communicate with the business process database 105 to obtain business process data such as the modeled business processes including their associated objects and links stored in the business process database 105. For example, the base list tool 50 may communicate with the business process database 105 using an application programming interface (API) or REST API through the business process manager 60 for purposes of allowing a user to leverage the business process database 105 to visualize and interact with business processes pertinent to a particular business solution and/or query. In some embodiments, the base list tool 50 may be configured to communicate with the business process database 105 through a separate computer system 110 provided by a service provider that includes the business process manager 60 and access to the business process database 105 based on a subscription and/or fee agreement.

In embodiments, the base list tool 50 may be a spreadsheet application for organization and analysis of business process data in tabular form that is built into a browser using programming language, such as HyperText Markup Language, tool kits, e.g., open source modular JavaScript library, such as Dojo toolkits, and/or widgets, such as website or application widgets to display and allow for interaction with business processes relevant to a particular solution request and/or query and the determined process integration points. The business solution and/or query may be any solution request and/or query associated with business processes of the enterprise. For example, a user (e.g., a business owner or stakeholder) may provide a solution request and/or query to the base list tool 50 that requests business process data for every activity an account payable clerk may perform across all business processes, or business process data for every activity that a credit manager might have to understand to perform a credit approval. However, it should be understood that the present invention is not limited to the above exemplary solution requests and/or queries and the solution requests and/or queries may include anything associated with business processes of the enterprise without departing from the spirit and scope of the present invention.

In response to the solution request and/or query from a user, the base list tool 50 may be configured to generate base lists comprising business process details including process integration points. For example, the base list tool 50 may retrieve each of the business processes including their associated objects and links from the business process database 105 that are related or impacted by business processes relevant to a particular solution request and/or query, and generate base lists comprising cell arrays having each of the business processes and their associated objects and links. Each cell of an array may be a model-view-controller element that can contains either numeric or text data, or the results of formulas that automatically calculate and display a value based on the contents of other cells. The numeric or text data include each of the business processes including their associated objects and links from the business process database 105 that are related or impacted by business processes relevant to the solution request and/or query.

Once the base lists are generated, the base list tool 50 may be configured to allow a user to interact with the base lists to sort and filter the data for further analysis. For example, a user of the base list tool 50 can make changes in any stored value and observe the effects on calculated values. This makes the spreadsheet useful for “what-if” analysis since many cases can be rapidly investigated without tedious manual recalculation. The base list tool 50 may have multiple interacting base lists, and can display the business process data either as text and numerals, or in graphical form using the interface tool 55.

More specifically, in embodiments, the interface tool 55 may communicate with the base list tool 50 to obtain business process details including process integration points for purposes of generating an illustration of the business process data. For example, the interface tool 55 may be configured to request business process details including process integration points from the base lists that are related or impacted by business processes relevant to the particular solution request and/or query. The interface tool 55 may be further configured to aggregate and visualize (e.g., illustrate) the particular business processes integrated with the business process integration points from the base lists. In some embodiments, the interface tool 55 may be a GUI built into a browser using programming language, such as HyperText Markup Language, tool kits, e.g., open source modular JavaScript library, such as Dojo toolkits, and/or widgets, such as website or application widgets (e.g., a GUI displayed on a computing device 14 as discussed with respect to FIG. 1) to visualize and allow for interaction with business processes relevant to the particular solution request and/or query and the determined process integration points.

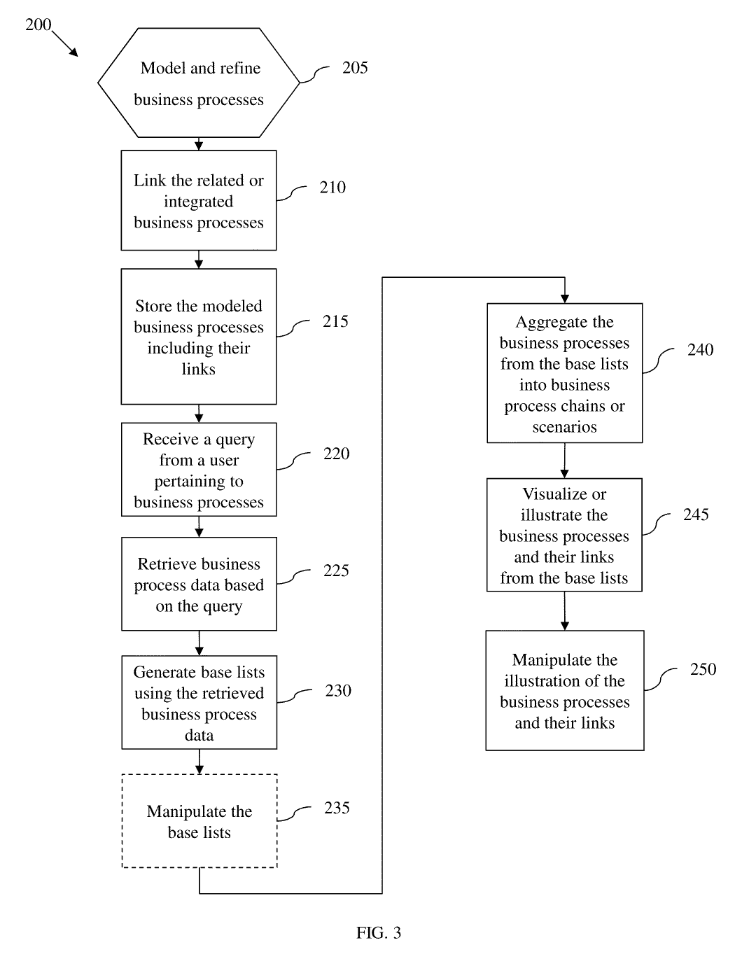

FIGS. 3, 10, and 11 show exemplary flows for performing aspects of the present invention. The steps of FIGS. 3, 10, and 11 may be implemented in the environments of FIGS. 1 and 2, for example. As noted above, the flowchart(s) illustrate the architecture, functionality, and operation of possible implementations of systems, methods, and computer program products as already described herein in accordance with the various embodiments of the present invention. The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

FIG. 3 is a flow diagram illustrating a process 200 for assessing and displaying business process content on a computing device in accordance with embodiments of the present invention. At step 205, business processes are modeled and refined based on business process data. As should be understood by those of ordinary skill in the art, the models may be generated and refined in a business process manager (e.g., business process manager 60 as described with respect to FIGS. 1 and 2) using a modeling technique, such as, Business Process Model and Notation, which is well known in the art, and thus will not be discussed in further detail. However, it should be understood by those of skill in the art that any number or combination of other modeling techniques, such as, Unified Modeling Language and Extended Business Modeling Language may be used to generate and refine the business models so long as the relationships of business activities are maintained in a manner that the interface tool could determine dependencies between business activities.

At step 210, the business processes may be linked at their process integration points. For example, one or more points in a business process where one or more other business processes are integrated with the business process may be determined and a link generated between the business processes in a business process manager (e.g., business process manager 60 as described with respect to FIGS. 1 and 2). In embodiments, a property (e.g., implementation type and metadata) of an object for one of the integrated business processes may be configured or edited to reference an object for the other of the integrated business processes, which implements an interface or link between the two business processes.

At step 215, the modeled business processes including their associated objects and links may be stored in memory (e.g., business process database 105 as described with respect to FIG. 2). In embodiments, the modeled business processes may be stored with reference to associated business scenarios and solutions, e.g., as a business flowchart. At step 220, a solution request and/or query may be received regarding business processes of an enterprise, e.g., a corporation. For example, a user (e.g., a business owner or stakeholder) may provide input into a tool (e.g., base list tool 50 or interface tool 55 as described with respect to FIGS. 1 and 2) that requests a business solution and/or business process information (e.g., information about relationships of business processes in a business solution) obtainable from the modeled business processes including their associated objects and links generated in steps 205 and 210. In embodiments, the solution request and/or query may be communicated from the tool using API or REST API through the business process manager for purposes of allowing a user to leverage the business process database to obtain business process data pertinent to the solution request and/or query.

At step 225, in response to the received and communicated solution request and/or query, the modeled business processes including their associated objects pertinent to the received solution request and/or query may be retrieved from the memory (e.g., the business process database 105 as described with respect to FIG. 2). For example, the business process manager (e.g., business process manager 60 as described with respect to FIGS. 1 and 2) may be configured to retrieve the modeled business processes including their associated objects from the database that are related or impacted by a business solution or business process relevant to the request and/or query. The business process manager may be further configured to forward the retrieved modeled business processes including their associated objects to the base list tool (e.g., the base list tool 50 as discussed in FIGS. 1 and 2) for subsequent processing. In some embodiments, the business process manager may be further configured to generate tabulated lists comprising the retrieved modeled business processes including their associated objects. In embodiments in which the business process manager generates the tabulated lists, once the tabulated lists are generated, the business process manager may be configured to forward the tabulated lists to the base list tool (e.g., the base list tool 50 as discussed in FIGS. 1 and 2) for subsequent processing.

At step 230, in response to the forwarding of the tabulated lists and/or the retrieved modeled business processes including their associated objects, base lists (e.g., a spreadsheet comprising rows and columns of data points for various variables) may be generated comprising the business process details including process integration points, and optionally displayed as a portion of a spreadsheet (e.g., displayed on I/O device 28 as described with respect to FIG. 1). For example, each of the business processes including their associated objects and links may be retrieved from the business process database that are related or impacted by business processes relevant to the solution request and/or query, and base lists may be generated comprising each of the business processes and their associated objects and links. The generating of the base lists may comprise creating cell arrays, populating each cell in the arrays with business processes and their associated objects, and linking the cells together based upon the associated objects and links thereof. Accordingly, each cell of an array may be created as a model-view-controller element that can contains either numeric or text data, or the results of formulas that automatically calculate and display a value based on the contents of other cells. The numeric or text data include each of the business processes including their associated objects from the business process database that are related or impacted by business processes relevant to the solution request and/or query.

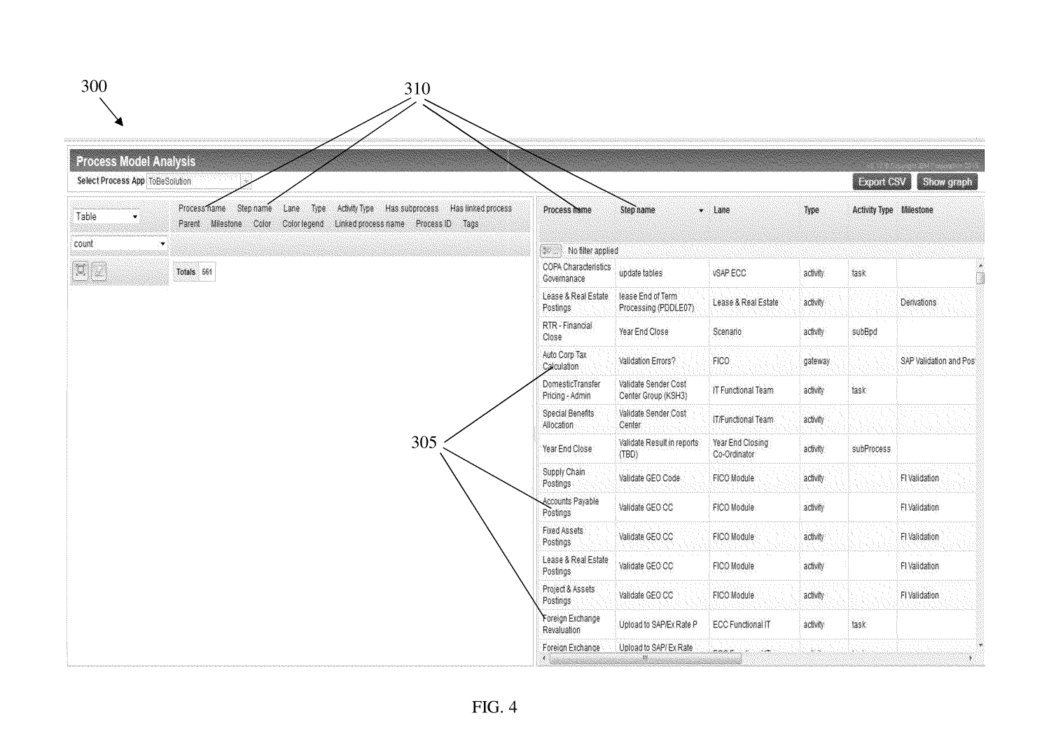

At step 235, optionally, the base lists may be manipulated. In embodiments, the base list tool may be used by a user to filter the business processes and their associated objects via any one or more variables at a particular time, manipulate sets of particular business processes and their associated objects to be viewed as a function of other sets of particular business process and their associated objects, and/or make changes in any stored value and observe the effects on calculated values, as discussed in detail herein with reference to FIGS. 4-7. This makes the base lists useful for “what-if” analysis since many cases can be rapidly investigated without tedious manual recalculation.

At step 240, the base lists may be interpreted to perform appropriate aggregations and to present the business processes appropriately grouped into business process chains or scenarios based on the process integration points. For example, the base lists may be analyzed by the interface tool (e.g., the interface tool 55 as described with respect to FIGS. 1 and 2), and the business processes from the base lists may be aggregated into process chains or scenarios based on their associated objects and links. The process chains or scenarios are a separate diagram on the sequence of the business processes (and business process variants) triggering each other and thereby forming an end-to-end process flow. These end to end process chains may be comprised of various business processes and business process variants executed in a logical order. The business processes and business process variants may belong to different business areas and process groups.

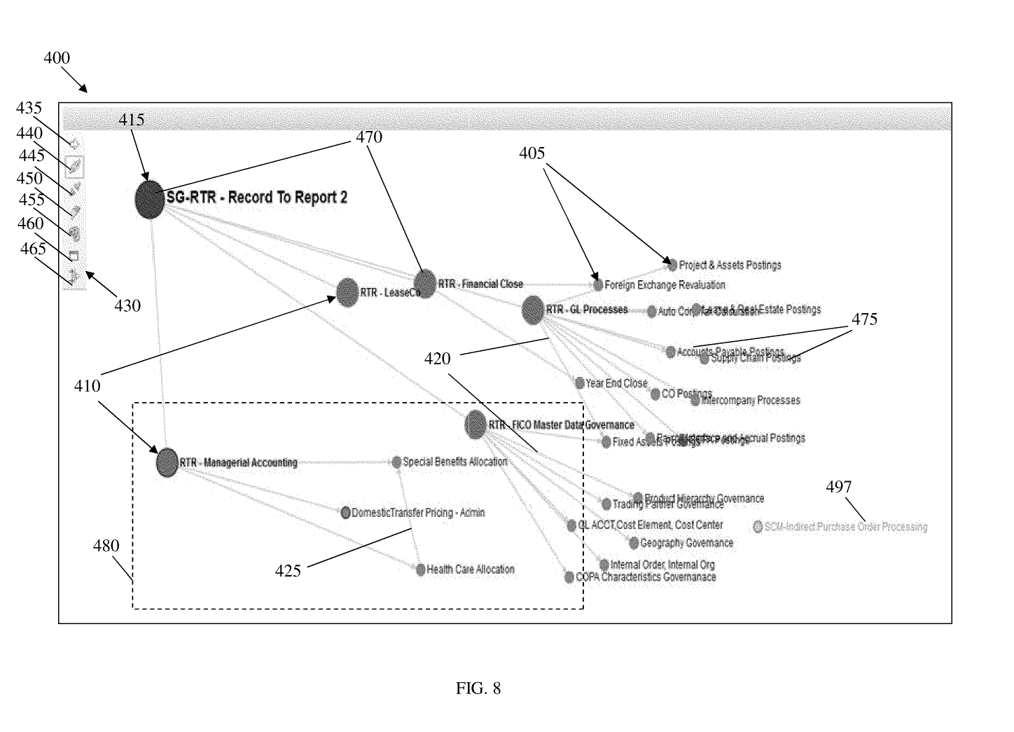

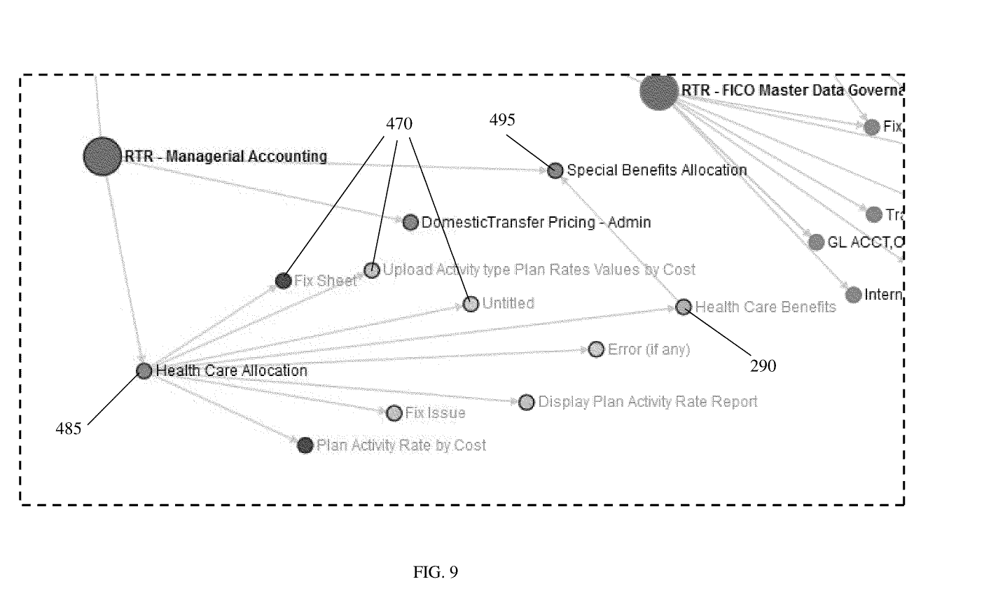

At step 245, the aggregated business processes integrated with the business process integration points from the base lists may be visualized or illustrated. For example, an illustration including the business processes grouped into scenarios associated with a particular end-to-end solution pertinent to the received query may be generated by the interface tool (e.g., interface tool 55 as described with respect to FIGS. 1 and 2) for display to a user. In embodiments, the illustration may be displayed as a portion of a GUI on a computing device (e.g., displayed on I/O device 28 of computing device 14 as discussed with respect to FIG. 1). At step 250, the illustration including the business processes grouped into scenarios may be manipulated. For example, a user may utilize a GUI (e.g., interface tool 55 as described with respect to FIGS. 1 and 2) to interact with the illustration to identify business process dependencies, evaluate impacts of changes to individual business processes, and evaluate completeness of solution design as represented by the business process models, as discussed in detail herein with reference to FIGS. 8 and 9.

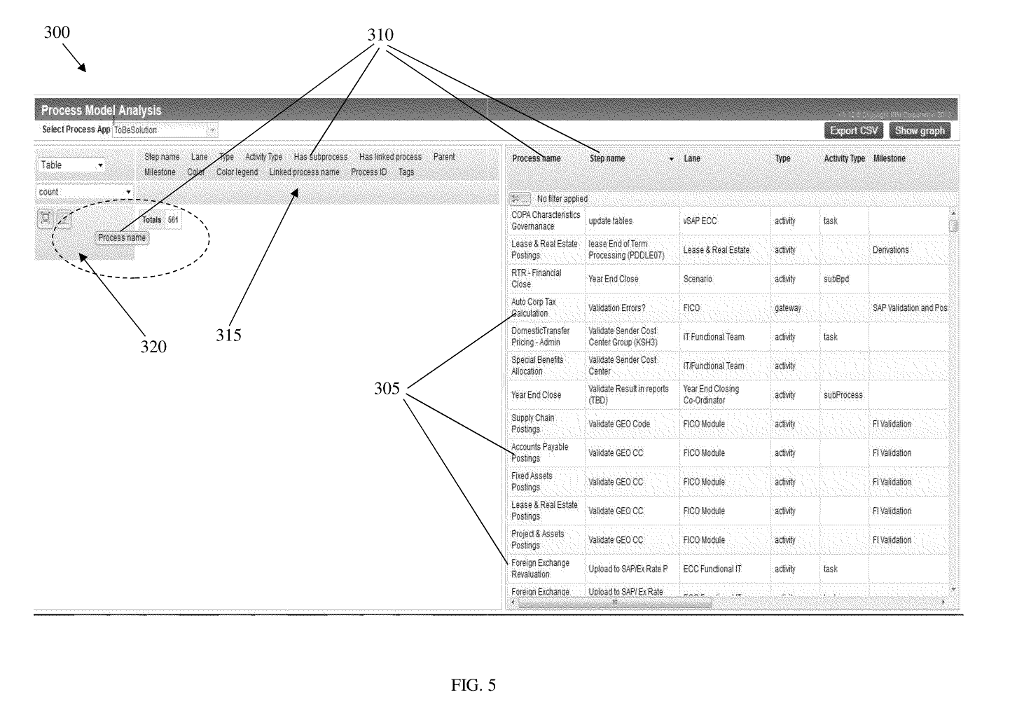

FIGS. 4-7 show different determinations, assessments, manipulations, and modifications of data from a data set that may be performed and displayed by the base list tool 50, as described with respect to FIGS. 1 and 2. As shown in FIG. 4, the interface tool 55 may be configured to generate base list 300 including business processes 305 pertinent to a received request and/or query, and displayed in view of selectable headers 310. In embodiments, the headers 310 may be configured to modify or filter the data for each of the business processes 305 shown in the illustration 300 based on one or more variables. For example, the data for each of the business processes 305 may be filtered using the base list tool 50 based on one or more variables, e.g., process name etc., by way of dragging or other methodologies the headers 310 from the list of headers 315 to a location 320 on the base list 300, as shown in FIG. 5.

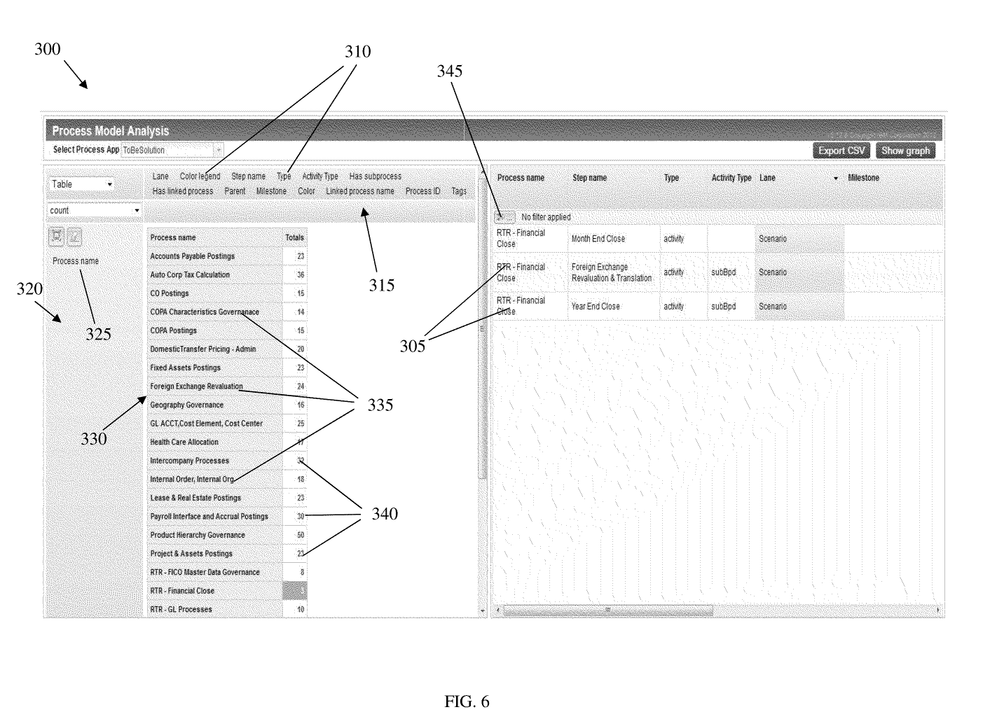

As shown in FIG. 6, by way of dragging or other methodologies the header 325 (process name) from the list of headers 315 to the location 320 on the base list 300, the filter window 330 is generated comprising the business processes 335 reorganized and filtered based on the header 325 and including a total number 340 of other business processes that interact with each business process 335 based on their process integration points (e.g., the process integration points are determined via the objects and links associated with each of the business processes 335). As should be understood, the use of the header 325 (process name) in base list 300 to sort the business processes 335 is merely illustrative of aspects of the present invention, and any number and/or combination of headers 310 may be manipulated (e.g., dragged) from the list of headers 315 to filter and rearrange the business processes 335 in the filter window 330 for further analysis without departing from the spirit and scope of the present invention.

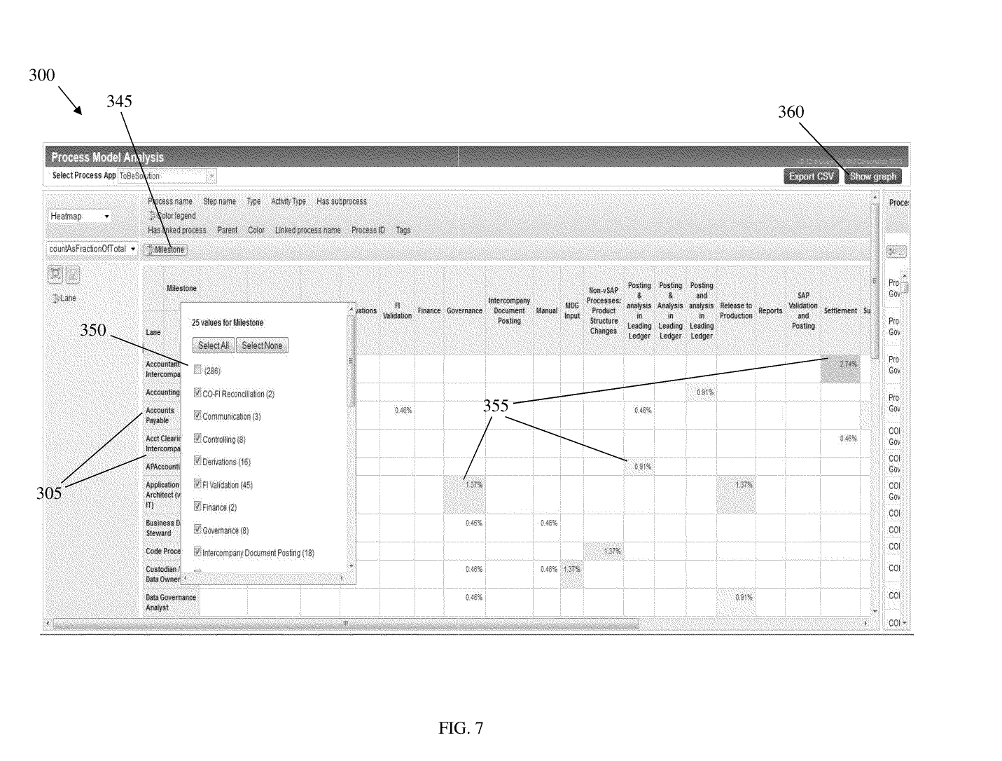

As shown in FIG. 7, additional filters may be applied to the business processes 305 via a toggle button or other methodology indicated by reference number 345. Adding a filter onto the set of business process data can be used to narrow down the data set to find data that is needed for a particular analysis. By selecting a certain data set, the business process data can be filtered and sorted amongst many rows or columns at once. For example, if a user wants to sort through the business processes 305 and find business processes 305 that have a milestone identified as controlling, to filter the data set, a user may select toggle button 345 and utilize a selection list 350 to select controlling from within a larger set of data to narrow or filter the data set of the business processes to only those having the value controlling under the header milestone. Accordingly, the toggle button or other methodology indicated by reference number 345 and the selection list 350 may be used to apply a filter to a data set comprising the business processes 305.

As also shown in FIG. 7, various cells 355 of the base list may be shaded a certain degree in order to denote additional information pertaining to data within each of the cells 355. For example, the shading may be used to indicate whether the business process 305 is on track for achieving a predetermined goal (e.g., the further away from achieving a goal, then the darker the shading of the cell). As should be understood, the use of shading in the cells 355 to identify whether the business processes 305 are on track for achieving a predetermined goal is merely illustrative of aspects of the present invention, and any type and/or combination of distinguishing features may be used within the cells to identify any number of pieces of information (e.g., whether the data for the business process is a certain percentage of completeness or accuracy) without departing from the spirit and scope of the present invention.

As also shown in FIG. 7, the base list 300 may be illustrated or visualized via a toggle button or other methodology indicated by reference number 360. For example, manipulation of the toggle button or other methodology indicated by reference number 360 may trigger the interface tool 55 to aggregate the business processes 305 from the base list 300 into business process chains or scenarios, and visualize or illustrate the business processes and their links, e.g., visualize or illustrate as a portion of a GUI.

FIGS. 8 and 9 show different determinations, assessments, manipulations, and modifications of data from a data set that may be performed and displayed by the interface tool 55, as described with respect to FIGS. 1 and 2. As shown in FIG. 8, the interface tool 55 may be configured to generate an illustration 400 including the business processes 405 grouped into scenarios 410 associated with a particular end-to-end solution 415 pertinent to the received request and/or query. In embodiments, the illustration 400 may be displayed as a portion of a GUI on a computing device (e.g., computing device 14 as discussed with respect to FIG. 1). The illustration 400 may further include links 420, e.g., arrows, which visualize an integration point or relationship between business processes. Additionally, the direction of the arrow may used to show additional detail such as which business process is connecting to or calling upon another business process as a parent process. For example, a user may not typically think of healthcare with respect to managerial accounting; however, the link 425 illustrates that the business process (health care allocation) is integrated or related to the business process (special benefits allocation). Additionally, the direction of the link 425 shows the user that the business process (health care allocation) is connecting to or calling the business process (special benefits allocation) as a parent process. Accordingly, it should be understood that the interface tool 55 using data from the base lists is able to illustrate business processes and business process integrations points in such a manner that a user can quickly and easily identify process dependencies.

In embodiments, the interface tool 55 may be further configured to allow a user to interact with the illustration 400. Specifically, the interface tool 55 may generate a GUI that includes tool bar 430 including selection tool 435, anchor tool 440, release tool 445, eraser tool 450, gear tool 455, base list tool 460, and filter tool 465. The selection tool 435 may be configured to allow a user to manipulate the solution 415, scenarios 410, and business processes 405 by selecting (e.g., mouse clicking) and/or dragging (e.g., mouse dragging) bubbles 470 provided for each selection. For example, the selection tool 435 may be used by the user to drag the bubbles 470 around in order to custom organize the illustration 400. For example, business processes 475 are presently illustrated with overlapping text; however, the selection tool 435 may be used by the user to select and drag the business processes 495 apart from one another for easier visualization of the solution 415. Additionally, the anchor tool 440 and the release tool 445 may be used in combination to make the bubbles 470 stick or anchor where they are positioned (e.g., the anchor tool 440) such that the bubbles cannot be moved around via the selection tool 435, or make the bubbles 470 release from where they are positioned (e.g., the release tool 445) such that the bubbles are free floating and may be moved around via the selection tool 435.

The eraser tool 450 may be used to make one or more of the business processes 405 and/or the links 420 not visible to the user. For example, the eraser tool 450 may be used to investigate how removal of an integration point between different business processes 405 may affect the solution 415 or the scenarios 410. The gear tool 455 may be used by a user to select a business process (health care allocation) and expand or drill down into the business process to further explore the business process activities and relationships of activities to other business processes, e.g., explore how exactly healthcare is affecting special benefits allocation. As can be seen in FIG. 9, which is an expanded view of the display area 480 from FIG. 8, selecting the healthcare allocation business process 485 reveals that the health care benefits business process 490 is directly affecting the special benefits allocation business process 495. Additionally, the bubbles 470 may be illustrated in distinguishing business activity types (e.g., a different color or texture bubbles) such that viewing the bubbles 470 provides a user with information such as whether the business process is performed automatically, manually, or with a third party system.

The base list tool 460 may be used by a user to return to and review the base lists, as discussed with respect to FIGS. 4-7. For example, a user may use the base list tool 460 to return to the base list 300 shown in FIG. 4 such that a user may review further details regarding each business process. The filter tool 265 may be used to apply a filter to the solution 415, scenarios 410, and/or business processes 405. Similar to the additional filter for the base list 300 discussed with respect to FIG. 7, adding a filter onto the set of business process data can be used to narrow down the data set to find data that is needed for a particular analysis. Accordingly, it should be understood that the interface tool 50 using data from the base lists is able to illustrate business processes and business process integrations points, and allow a user to manipulate and interact with the illustration in such a manner that a user can quickly and easily evaluate impacts of changes to each business process 405, scenario 410, or solution 415 as well as potential impacts to related business processes that share common business activities.

With reference back to FIG. 8, in some embodiments, the illustration 400 may further allow for visualization of completeness of the solution design as represented by the business process models by illustrating instances where business processes have no interaction with other business processes or shared business process activities. For example, business process 497 (indirect purchase order processing) is illustrated in a distinguishing type (e.g., a lighter color font) without any links 420 to other business processes. Therefore, a user reviewing the illustration 400 should be able to evaluate that the process design of the solution 415 is incomplete by quickly identifying that business process 497 is either not defined properly because the business process 497 is not linked to any other business processes, or if the business process 497 is defined properly then the user can investigate why the business process 497 is being performed since it has no impact on anything else the business is doing. Accordingly, it should be understood that the interface tool 55 using data from the base lists is able to illustrate business processes and business process integrations points and allow a user to evaluate completeness of the solution design as represented by the business process models.

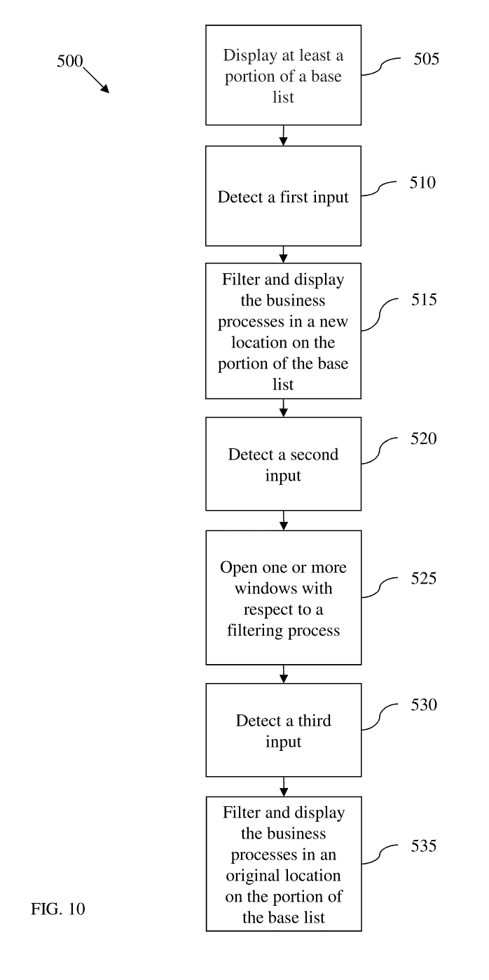

FIG. 10 is a flow diagram illustrating a process 500 for interacting with business process content on a computing device in accordance with embodiments of the present invention. At step 505, the computing device displays at least a portion of a base list comprising a business solution on a screen display. The business solution comprises content such as business processes (e.g., business processes 310, FIGS. 4 and 5). In embodiments, at least a portion of the content may be displayed using modified text or graphics to distinguish a portion of the content from other portions of the content and provide a user with additional information concerning a portion of the content. For example, as described with respect to FIG. 7, the cells 355 may be illustrated in distinguishing types (e.g., different shades of color).

In embodiments, the base list may be presented as a web page. In additional or alternative embodiments, the base list may be presented as a hyper text markup language (HTML) or extensible markup language (XML) document.

At step 510, a first input (e.g., selecting and/or dragging, FIG. 5) may be detected on an item of business process content (e.g., header 310, FIG. 5) in the displayed portion of the base list. At step 515, in response to detecting the first input, the business processes may be filtered based on the item of business process content, and displayed in a separate location of the portion of the base list that is different from where the item of business process content and the business processes are originally displayed. In embodiments, the manipulation of the item of business process content may comprise pulling or dragging the item of business process content around on the display in order to custom organize the business solution. In embodiments, the selection and/or manipulation of the business process content via the first input may further include displaying a total number of other business processes that interact with each business process based on their process integration points (e.g., the process integration points are determined via the objects and links associated with each of the business processes).

While the portion of a base list is displayed, at step 520, a second input (e.g., activation of an additional filter, FIG. 7) may be detected on a toggle button or other methodology (e.g., toggle button represented by reference number 345, FIG. 7) in the displayed portion of the business solution. At step 525, in response to detecting the second input, one or more graphical windows may be opened and displayed. In embodiments, the one or more graphical windows may include a filter box for filtering the solution and/or business processes.

In embodiments, displaying the one or more windows may comprise displaying the one or more graphical windows on top of the displayed portion of the base list. For example, the one or more windows may be superimposed on top of the displayed portion of the base list. In some embodiments, the one or more windows may be semitransparent or opaque. In alternative embodiments, displaying the one or more windows may comprise opening the one or more windows in a separate web page.

At step 530, a third input (e.g., activation of an additional filter, FIG. 7) may be detected in the filter box in the displayed portion of the business solution. At step 535, in response to detecting the third input, the solution and/or business processes may be filtered, and displayed in the original location of the portion of the base list that the business processes are displayed.

In embodiments, the first, second, and third input may be received via an input device such as I/O device 28 (e.g., a mouse click). In embodiments, the first, second, and third input may be received in combination with use of control items such as the headers 310 and the toggle button represented by reference number 345, as described with respect to FIGS. 4-7.

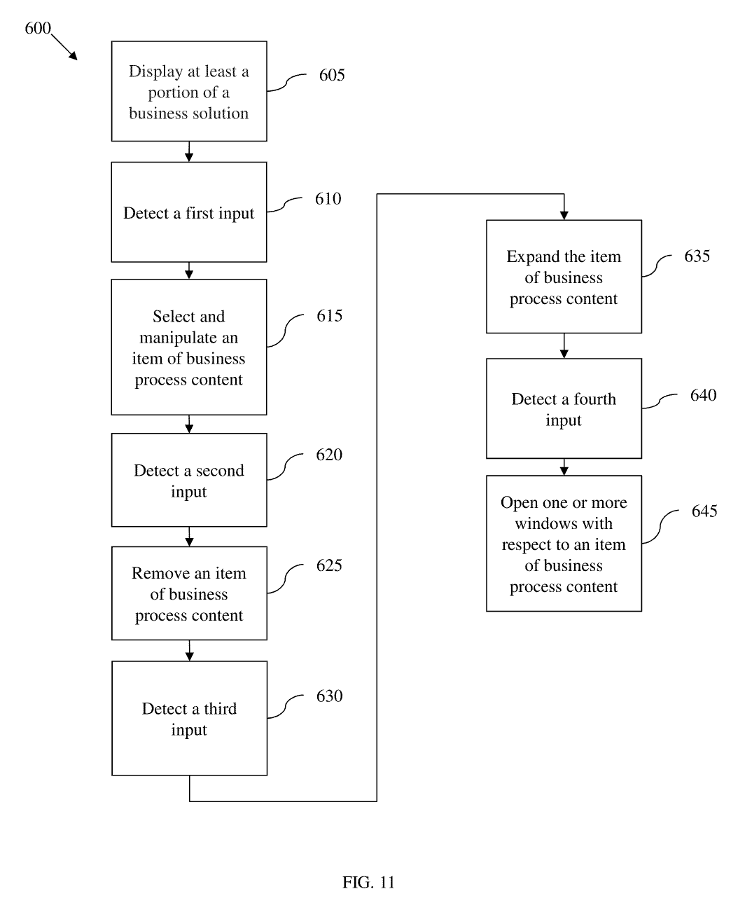

FIG. 11 is a flow diagram illustrating a process 600 for interacting with business process content on a computing device in accordance with embodiments of the present invention. At step 605, the computing device displays at least a portion of a business solution on a screen display. The business solution comprises content such as business processes and scenarios (e.g., business processes 605 and business scenarios 610, FIGS. 8 and 9). In embodiments, at least a portion of the content may be displayed using modified text or graphics to distinguish a portion of the content from other portions of the content and provide a user with additional information concerning a portion of the content. For example, as described with respect to FIGS. 8 and 9, the bubbles 470 may be illustrated in distinguishing business activity types (e.g., a different color or texture bubbles) and/or the business process 497 (indirect purchase order processing) may be illustrated in a distinguishing type (e.g., a lighter color font).

In embodiments, the business solution may be presented as a web page. In additional or alternative embodiments, the business solution may be presented as a hyper text markup language (HTML) or extensible markup language (XML) document.

At step 610, a first input (e.g., selection via selection tool 435, FIG. 8) may be detected on an item of business process content (e.g., bubble 470 of a business process 405, FIG. 8) in the displayed portion of the business solution. At step 615, in response to detecting the first input, the item of business process content may be selected and/or manipulated on the display and other content in the business solution besides the selected item of business process content may cease to be active for manipulation. In embodiments, the manipulation of the item of business process content may comprise pulling or dragging the item of business process content around on the display in order to custom organize the business solution. In embodiments, the selection and/or manipulation of the business process content via the first input may further include sticking the business process content to a selected or determined location on the display (e.g., anchor tool 440, FIG. 8). In embodiments, the selection and manipulation of the business process content via the first input may further comprise releasing the business process content from a selected or determined location on the display (e.g., release tool 445, FIG. 8).

While the portion of a business solution is displayed, at step 620, a second input (e.g., removal via eraser tool 450. FIG. 8) may be detected on an item of business process content (e.g., business process 405 and/or the links 420, FIG. 8) in the displayed portion of the business solution. At step 625, in response to detecting the second input, the item of business process content may be removed from the display of the business solution and other content in the business solution besides the removed item of business process content remains for display. In embodiments, ceasing to display the removed item of business process content in the business solution may comprise completely removing the item of business process content from the business solution or fading out the item of business process content as compared to the other content in the business solution.

While the portion of a business solution is displayed, at step 630, a third input (e.g., expansion via gear tool 455, FIG. 8) may be detected on an item of business process content (e.g., bubble 470 of a business process 405, FIG. 8) in the displayed portion of the business solution. At step 635, in response to detecting the third input, the item of business process content may be expanded or opened on the display. In embodiments, the expansion or opening of the item of business process on the display may comprise expanding the display of the portion of the business solution to reveal additional portions of the business solution (e.g., greater detail) regarding the item of the business process (e.g., business process 485 in FIG. 9). In embodiments, the displaying of the additional portions of the business solution may comprise displaying additional business processes, scenarios, and/or links there between related or associated with the item of the business process content.

While the portion of a business solution is displayed, at step 640, a fourth input (e.g., returning to the base list via base list tool 460 or applying a filter via filter tool 465, FIG. 3) may be detected on an item of business process content (e.g., bubble 470 of a business process 205. FIG. 3) in the displayed portion of the business solution. At step 645, in response to detecting the fourth input, one or more graphical windows may be opened and displayed. In embodiments, the one or more graphical windows may include a base list for viewing or manipulating the base list, e.g., base list 300 discussed with respect to FIGS. 4-7. In additional or alternative embodiments, the one or more graphical windows may include a filter box for filtering the solution, scenarios, and/or business processes.

In embodiments, displaying the one or more windows may comprise displaying the one or more windows on top of the displayed portion of the business solution. For example, the one or more windows may be superimposed on top of the displayed portion of the business solution. In some embodiments, the one or more windows may be semitransparent or opaque. In alternative embodiments, displaying the one or more windows may comprise opening the one or more windows in a separate web page.

In embodiments, the first, second, third, and fourth input may be received via an input device such as I/O device 28 (e.g., a mouse click). In embodiments, the first, second, third, and fourth input may be received in combination with use of control items such as the selection tool 435, the anchor tool 440, the release tool 445, the eraser tool 450, the gear tool 455, the base list tool 460, and the filter tool 265, as described with respect to FIGS. 8 and 9.

As should be understood aspects of the present invention allow for a user to leverage modeling tool databases to visualize and interact with business processes pertinent to a particular business solution and/or query. Conventionally, a user was capable of viewing models generated from modeling tool databases to manually review flowcharts and lists of data. However, these conventional systems and methods rely on human knowledge and testing to understand the business process integration and dependencies within the business solutions illustrated via the flowcharts and lists of data. Accordingly, due to cost and time restraints most users, e.g., business managers, would not investigate queries into aspects of the business processes, such as, determining why particular business processes are integrated with one another, or investigate completeness of a solution design, such as, identifying all business process not linked to at least one other business process.

In contrast to the conventional systems and methods, the aspects of the present invention advantageously allow for users to query difficult questions and quickly identify business process dependencies, evaluate impacts of changes to individual business processes, and evaluate completeness of solution design as represented by the business process models. In embodiments, advantageously, the visualization, e.g., graphic user interface, provides for improved business solution transparency, visual analysis of process change impacts, interactive business solution audit and review, visibility to completeness of the business solution, and real-time visualization of the business solution, e.g., changes in the solution design may be seen immediately.

In embodiments, the invention provides a method that performs the process of the invention on a subscription, advertising, and/or fee basis. That is, a service provider, such as a Solution Integrator, could offer to provide business process assessment and visualization functionality to a request for information or data on a network. In this case, the service provider can create, maintain, support, etc., a computer infrastructure, such as computer system 12 (as shown in FIG. 1) that performs the processes of the invention for one or more consumers. In return, the service provider can receive payment from the consumer(s) under a subscription and/or fee agreement and/or the service provider can receive payment from the sale of advertising content to one or more third parties.

In still another embodiment, the invention provides a computer-implemented method for assessing and visualizing the business process data in response to receiving a request for information or data on a network. In this case, a computer infrastructure, such as computer system 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method implemented in a computer infrastructure having computer executable code tangibly embodied on a computer readable storage medium having programming instructions operable to:
aggregate business process data from base lists into business process chains or scenarios comprising at least one link between two or more business processes;
display, at a computing device with a screen display, at least a portion of a business solution on the screen display, wherein the portion of the business solution comprises the business process chains or scenarios;
detect a first input at a location of a first item of the business process chains or scenarios on the displayed portion of the business solution;
in response to the detecting the first input, select the first item and manipulating the first item on the displayed portion of the business solution relative to other items of the business process chains or scenarios:
detecting a second input at a location of a second item of the business process chains or scenarios on the displayed portion of the business solution; and
in response to the detecting the second input, expand the second item to display additional items of the business process chains or scenarios on the screen display including the at least one link between the two or more business processes.

2. The method of claim 1, wherein:
the first item is a first business process implemented in the business solution;
the second item is a second business process different from the first business process and implemented in the business solution; and
the additional items further include business processes related to the second business process.

3. The method of claim 2, wherein the programming instructions are further operable to illustrate the at least one link between one of the business processes related to the second business process and the first business process.

4. The method of claim 3, wherein the programming instructions are further operable to:
detect a third input at a location of a third item of the business process chains or scenarios on the displayed portion of the business solution; and
in response to the detecting the third input, remove the third item from the portion of the business solution.

5. The method of claim 4, wherein:
the third item is a third business process implemented in the business solution; and
the removal of the third item from the portion of the business solution comprises ceasing to display the removed third item in the portion of the business solution and continuing to display the business process chains or scenarios without the removed third item in the portion of the business solution.

6. The method of claim 5, wherein the programming instructions are further operable to:
detect a fourth input at a location of a fourth item of the business process chains or scenarios on the displayed portion of the business solution; and
in response to the detecting the fourth input, display one or more windows comprising the base lists or a selectable filter.

7. The method of claim 6, wherein:
the fourth item is a fourth business process implemented in the business solution; and
the base lists comprise further details regarding the fourth business process.

8. The method of claim 6, wherein:
the fourth item is a fourth business process implemented in the business solution; and
the selectable filter is configured to filter the business process chains or scenarios based on the fourth business process.

9. A computer program product for assessing and displaying business process data, the computer program product comprising a computer readable storage medium having program instructions embodied therewith, the program instructions readable by a computing device to cause the computing device to:
Retrieve business processes and associated objects from a database that are relevant to a received request for the business process data, wherein a first object of the associated objects for a first business process of the business processes is configured to reference a second object of the associated objects for a second business process of the business processes, which implements an interface or link between the first business process and the second business process;
generate one or more base lists comprising the business processes and the associated objects;
aggregate the business processes and the associated objects from the one or more base lists into business process chains or scenarios comprising the interface or link between the first business process and the second business process; and
display a graphical user interface including at least a portion of a business solution on a screen display, wherein the portion of the business solution comprises the business process chains or scenarios.

10. The computer program product of claim 9, wherein:
the displaying the graphical user interface comprises displaying a tool bar comprising a plurality of tools within the graphical user interface;
a first tool of the plurality of tools is configured to cause the computing device to generate a first input at a location of a first item of the business process chains or scenarios on the portion of the business solution; and
in response to the first input, the graphical user interface is configured to cause the computing device to select the first item and manipulate the first item on the portion of the business solution relative to other items of the business process chains or scenarios.

11. The computer program product of claim 10, wherein:
the first item is the first business process:
the other items comprise the second business process; and
the portion of the business solution further comprises the interface or link between the first business process and the second business process.

12. The computer program product of claim 11, wherein the interface or link is an arrow, and a direction of the arrow is configured to illustrate whether the first business process is calling on the second business process or the second business process is calling on the first business process.

13. The computer program product of claim 12, wherein:
a second tool of the plurality of tools is configured to cause the computing device to generate a second input at a location of the second business process; and
in response to the second input, the graphical user interface is configured to cause the computing device to expand the second business process to display additional items of the business process chains or scenarios within the portion of the business solution.

14. The computer program product of claim 13, wherein the additional items further include business processes related to the second business process and one or more interfaces or links between the business processes.

15. The computer program product of claim 14, wherein:
a third tool of the plurality of tools is configured to cause the computing device to generate a third input at a location of a third item of the business process chains or scenarios on the portion of the business solution; and
in response to the third input, the graphical user interface is configured to cause the computing device to remove the third item from the portion of the business solution.

16. The computer program product of claim 15, wherein:
the third item is a third business process implemented in the business solution; and
the removal of the third item from the portion of the business solution comprises ceasing to display the removed third item in the portion of the business solution and continuing to display t the business process chains or scenarios without the removed third item in the portion of the business solution.

17. The computer program product of claim 16, wherein:
a fourth tool of the plurality of tools is configured to cause the computing device to generate a fourth input at a location of a fourth item of the business process chains or scenarios on the portion of the business solution; and
in response to the fourth input, the graphical user interface is configured to cause the computing device to display one or more windows comprising the one or more base lists or a selectable filter.

18. The computer program product of claim 17, wherein:
the fourth item is a fourth business process implemented in the business solution; and
the base lists comprise further details regarding the fourth business process.

19. The computer program product of claim 17, wherein:
the fourth item is a fourth business process implemented in the business solution; and
the selectable filter is configured to filter the business process chains or scenarios based on the fourth business process.

20. A system comprising:
a CPU, a computer readable memory and a computer readable storage medium;
program instructions to model business processes;
program instructions to analyze the modeled business processes and determine links between the business processes at their integration points;
program instructions to store the modeled business processes and the determined links between the business processes in a database;
program instructions to receive a query pertaining to business processes;
program instructions to retrieve one or more modeled business processes and associated links between the one or more business processes from the database based on the query;
program instructions to generate and display base lists comprising the retrieved one or more modeled business processes;
program instructions to detect a first input at a location of a first item of the retrieved one or more modeled business processes; and
program instructions that in response to the detecting the first input, filter and display the retrieved one or more modeled business processes based on the first item,
wherein the displaying the retrieved one or more modeled business processes based on the first item comprises displaying a total number of business processes related to each of the one or more modeled business processes based on the determined links between the business processes; and
wherein the program instructions are stored on the computer readable storage medium for execution by the CPU via the computer readable memory.
